(19) United States
(12) Patent Application Publication
(10) Pub. No.: US 2010/0178082 A1
(43) Pub. Date: Jul. 15, 2010

(54) Developing Device and Process Cartridge and Imaged Forming Device Provided with them

(76) Inventor: Hiromitsu Suzuki, Ibaraki (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/596,993

(22) PCT Filed: May 19, 2005
(86) PCT No.: PCT/JP05/09193

§ 371 Date: Sep. 17, 2007

(30) Foreign Application Priority Data
May 19, 2004 (JP) 2004-148703

(51) Int. Cl. G03G 15/09

(52) U.S. Cl. 399/277

(57) ABSTRACT

Object: To prevent trailing and leading to enable excellent development with a simple constitution.

Solving Means: A maximum value F0 of a magnetic attractive force near a main magnetic pole S1 of magnetic poles formed by a magnetic field generating unit 3 of a developing apparatus 1 is positioned on a downstream side in a rotating direction of a developer carrier 2 beyond a peak position of a magnetic flux density in a normal line direction of the main magnetic pole S1, for example on the downstream side in the rotating direction of the developer carrier by at least 8° or more from the peak position of the magnetic flux density in the normal line direction of the main magnetic pole S1, and a half-value width of the maximum value F0 of the magnetic attractive force has a narrow and peaked distribution of, for example, 54° or less.

### TECHNICAL FIELD

The present invention relates to a developing apparatus and a process cartridge which are used in an image forming apparatus of an electrophotographic system or an electrostatic recording system such as a copying machine or a page printer, and to an image forming apparatus including the developing apparatus and the process cartridge.

### BACKGROUND ART

In an image forming apparatus using an electrophotographic system, an electrostatic latent image formed on an image carrier is developed by a developing apparatus to be visualized, and as the developing apparatus, a developing apparatus using toner has been put in practical use widely. Like an LED or LBP printer, a recent image forming apparatus has become an apparatus having a higher resolution, in association with which a higher-resolution and high-definition developing system is required.

In order to realize high image quality, it is necessary to charge toner (developer) contained in a developing container of a developing apparatus sufficiently. This is because, when a Q/M [Q/M: toner charge amount (μQ) per unit weight (g)] of toner on a developing sleeve is small, toner scattering or a toner coat amount W is increased, so that a chain-like particle cluster of toner at developing time becomes large, the particle cluster is fallen over and “trailing” is generated at a trailing end of an image, which degrades the image. Therefore, for example, a thin-layer developing apparatus according to an elastic developing blade method where a toner coat amount W [W: toner coat weight (mg) per square centimeter of a surface of a developing sleeve] on a developing sleeve (developer carrier) is reduced by causing a developing blade (developer restricting member) made of, for example, an elastic body to abut on the developing sleeve with a high pressure, and simultaneously toner on the developing sleeve is applied with a large Q/M has been developed conventionally.

However, when the developing blade made of an elastic body is caused to abut on the developing sleeve with a high pressure and the toner on the developing sleeve is applied with a high Q/M, there is a problem that much toner charged to reverse polarity is generated, which generates “leading” which means development of unnecessary toner at a leading end of the image. Moreover, even if the Q/M is made high so that a toner coat amount is reduced, there is a problem that a chain-like particle cluster is fallen down due to difference in circumferential velocity between a paper and a photosensitive drum at a time of transferring, which generates trailing.

On the other hand, a magnet roller (magnetic field generating unit) for retaining/conveying toner (developer) is disposed in a fixed state inside the above-described developing sleeve (developer carrier), but for example in a developing apparatus disclosed in Patent Literature 1 described below, such a configuration is made that an excellent development effect can be obtained by disposing a main magnetic pole of plurality of magnetic poles provided on a magnet roller at a position corresponding to a developing region, and high image quality is attained by setting magnetic flux density and a magnetic attractive force in addition to magnetic flux density and a distribution thereof.

That is, in Patent Literature 1 described below, a maximum value F0 of the magnetic attractive force of the magnet roller is set in a downstream of a developing sleeve rotating direction beyond a peak of a developing pole S1, and a minimum value F2 is set near a peak position of the developing pole S1, but in a distribution of the magnetic attractive force at the case, there is a problem that an N1 pole and an N2 pole adjacent to the developing pole S1 make an influence, so that the respective magnetic poles are forced to be positioned so as to separate from one another by about 90°, and application can be therefore performed to only a distribution of a magnetic flux density limited to a certain extent.

For example, recently, in an image forming apparatus where price-reduction and space-saving are attained by employing a vertical paper path configuration where a paper is conveyed in a vertical direction, instead of a horizontal path which has been used conventionally, such a configuration has been adopted that a photosensitive drum moves upwardly and the developing pole S1 and the developing blade approaches to each other according to the vertical path configuration, so that, when the S1 pole—the N1 pole is separated by about 90° as described above, an N1 pole peak position is disposed at a nip portion of the developing blade. That is, when the N1 pole peak position is disposed at the nip portion of the developing blade, toner coat on the developing sleeve becomes uneven, which may generate uneven density, so that it is desired to displace the N1 pole so as to separate from the nip portion by at least about 30°, but when the N1 pole is displaced toward the S1 pole side by 30°, the N1 pole cannot be magnetized sufficiently because the N1 pole is too close to the S1 pole.

Patent Literature 1: JP-B-07-066215

### DISCLOSURE OF THE INVENTION

### Problem to be Solved by the Invention

Then, an object of the present invention is to provide a developing apparatus and a process cartridge where both trailing and leading are prevented to attain image quality improvement even in the developing apparatus of a thin-layer developing system where the respective magnetic poles of the magnetic roller cannot be disposed at intervals of about 90°.

### Means for Solving the Problem

In order to attain the object, according to a first invention according to the present application, the object is attained by a developing apparatus comprising a developer carrier which is disposed opposite to an electrostatic latent image carrier and carries a developer to rotate, and a magnetic field generating unit which is fixedly disposed inside the developer carrier and has a plurality of magnetic poles including a main magnetic pole positioned in a developing region, the main magnetic pole of the magnetic field generating unit having a peak of magnetic flux density in a normal line direction near a proximity position of the electrostatic latent image carrier and the developer carrier and being configured so as to generate a magnetic attractive force which is a resultant force of an attractive force based on the magnetic flux density in the normal line direction and an attractive force based on magnetic flux density in a tangential line direction on the developer carrier by the magnetic field generating unit, wherein a magnetized pattern where a maximum value F0 of the magnetic attractive force F is positioned on a downstream side in a rotating direction of the developer carrier beyond a peak position of the magnetic flux density in the normal line direction of the main magnetic pole, and a half-value width of the maximum value F0 of the magnetic attractive force becomes smaller than that of the magnetic flux density in the normal line direction in the main magnetic pole is applied to the magnetic field generating unit.

According to a second invention according to the present application, the object is attained by adopting such a constitution that developer has a weight average particle diameter of 3.0 to 7.2 μm and an MI value of 3 to 30 g/10 min and a developer amount W [W: toner coat amount (mg) per square centimeter of a surface of the developer carrier] layered on the above-described developer carrier satisfies 0.6≦W≦1.5, or adopting such a constitution that the maximum value F0 of the above-described magnetic attractive force is positioned on the downstream side by at least 8° or more in the rotating direction of the developer carrier from the peak position of the magnetic flux density in the normal line direction of the main magnetic pole and a half-value width of the maximum value F0 of the above-described magnetic attractive force has a distribution within a range of 54° or less, or adopting such a constitution that a 90% width of the maximum value F0 of the above-described magnetic attractive force is set to 20° or less.

According to a third invention according to the present application, the object is attained by a process cartridge configured by arranging either one or more than one of an electrostatic latent image carrier, a charging device, a transferring device, and a cleaner, and a developing apparatus in a casing attachably and detachably accommodated in an image forming apparatus, the developing apparatus comprising a rotatable developer carrier, a magnetic field generating unit which is fixedly disposed inside the developer carrier and has a plurality of magnetic poles including a main magnetic pole positioned in a developing region, a developer restricting member abutting on the developer carrier, and a developing container containing developer supplied to the developer carrier, where the developer has a weight average particle diameter of 3.0 to 7.2 μm and an MI value of 3 to 30 g/10 min, and a developer amount W [W: toner coat amount (mg) per square centimeter of a surface of the developer carrier] layered on the developer carrier satisfies 0.6≦W≦1.5, wherein the main magnetic pole has a peak of magnetic flux density in a normal line direction at a proximity position of the electrostatic latent image carrier and the developer carrier, generates a magnetic attractive force which is a resultant force of an attractive force based on the magnetic flux density in the normal line direction and an attractive force based on a magnetic flux density in a tangential line direction on the developer carrier by the magnetic field generating unit, a maximum value F0 of the magnetic attractive force is positioned on a downstream side in a rotating direction of the developer carrier by at least 8° or more from the peak position of the magnetic flux density in the normal line direction of the main magnetic pole, and a half-value width of the maximum value F0 of the magnetic attractive force has a distribution of 54° or less.

According to a fourth invention according to the present application, the object is attained by setting a 90% width of the maximum value F0 of the magnetic attractive force to 20° or less.

According to a fifth invention according to the present application, the above-described object is attained by an image forming apparatus wherein the developing apparatus or the process cartridge in either one of the respective inventions described above is provided.

### EFFECT OF THE INVENTION

As described above, according to the first, the second, the fourth, or the fifth invention according to the present application, since the maximum value F0 of the magnetic attractive force near the main magnetic pole of the magnetic poles formed by the magnetic field generating unit of the developing apparatus is positioned on the downstream side in the rotating direction of the developer carrier beyond the peak position of the magnetic flux density in the normal line direction of the main magnetic pole, for example on the downstream side in the rotating direction of the developer carrier by at least 8° or more from the peak position of the magnetic flux density in the normal line direction of the main magnetic pole, and the half-value width of the maximum value F0 of the magnetic attractive force has a narrow and peaked distribution of, for example, 54° or less, trailing and leading are prevented and an excellent development can be performed.

According to the third, the fourth or the fifth invention according to the present application, in the process cartridge where either one or more than one of the electrostatic latent image carrier, the charging device, the transferring device, and the cleaner, and the developing apparatus are disposed in the casing and integrated therewith, and the casing is configured so as to be attachable to/detachable from the image forming apparatus main body, since the magnetic field generating unit used in the first and second inventions are used as a magnetic field generating unit used in the developing apparatus in the cartridge, an effect of preventing trailing and leading and performing an excellent development owing to the first and the second inventions can be obtained, and it becomes possible to exchange these components easily, so that maintenance easiness of the image forming apparatus can be improved.

### BEST MODE FOR CARRYING OUT THE INVENTION

Embodiments of the present invention will be explained below in detail with reference to the drawings.

A developing apparatus 1 of a first embodiment according to the present invention shown in FIG. 1 is used in an image forming apparatus such as a laser printer, and it is provided with a function of developing an electrostatic latent image formed on a surface of a photosensitive drum 11 serving as an electrostatic latent image carrier.

A developing sleeve 2 serving as a developer carrier disposed opposite to the photosensitive drum 11 which is the above-described electrostatic latent image carrier is disposed inside the developing apparatus 1, and a magnet roller 3 serving as a developer carrier is fixedly disposed in the developing sleeve 2. A developing blade 4 serving as a developer amount restricting member for restricting a developer amount is disposed on a surface of the developing sleeve 2 so as to abut on a predetermined position, and only an appropriate amount of toner (not shown) serving as magnetic developer for visualizing an electrostatic latent image is charged from a toner supplying port 5a of a developing hopper 5 which is a developing container and contained in the developing hopper 5.

For the magnetic developer in the embodiment, the following negative electric magnetic monocomponent toner is used, for example. That is, such toner is employed that is obtained by melting and kneading 100 weight parts of styrene n-butyl acrylate copolymer as binder resin, and 80 weight parts of magnetic particle, 2 weight parts of negative charge control agent of monoazo iron complex, and 3 weight parts of low mol. wt. polypropylene as wax by a biaxial extruder heated to 140° C., coarsely crushing the cooled-down kneaded mixture by a hammer mill, finely pulverizing the coarsely-crushed material by a jet mill, and air-classifying the obtained pulverized material to obtain a classified powder having a weight average diameter of 5.0 μm, and then, mixing 1.0 weight part of hydrophobic silica fine powder to the classified material which has an average particle diameter of 5.0 μm by a Henschel mixer.

A melt index (MI) which is a fixing index of the toner indicates 20 g/10 min, for example. Measuring the melt index (MI) is performed using an apparatus (an apparatus used in a flow test method for thermoplastic) described in JISK7210, and measuring conditions at the time are, for example, as follows:

Under a condition that as a measurement temperature is 125° C., a load is 5 kg, and a sample filling amount is in a range of 5 to 10 g, measurement is performed by a manually cutting method, and the measured value at that time is converted to a 10-min value. For measuring an average particle diameter of the toner, a Coulter Multisizer II (made by BECKMAN COULTER, Inc.) is used to obtain a weight average particle diameter D4 (μm) based on weight from a volume distribution of the toner. Incidentally, as a toner of the developing apparatus of the embodiment, a toner having an MI of 3 to 30 g/10 min and a weight average particle diameter of 3.0 to 7.2 μm can be used.

A sleeve which is a nonmagnetic aluminum sleeve with a diameter of φ16.0 whose surface roughness Ra=1.0 μm is coated with a resin layer containing conductive particles is used for the developing sleeve 2 disposed opposite to the above-described photosensitive drum 11, and the sleeve can rotate in a counterclockwise direction to convey the toner in a direction toward the photosensitive drum 11. The developing sleeve 2 and the photosensitive drum 11 are opposed to each other and there is a gap of 300 μm between them at a closest position. The magnet roller 3 fixedly disposed in the developing sleeve 2 can form magnetic fields at least four portions of an N1 pole, an S2 pole, an N2 pole, and an S1 pole on the developing sleeve 2, respectively. An arrangement relationship of these magnetic poles will be described later.

Further, the developing blade 4 abutting on the developing sleeve 2 to restrict a developer amount is formed from, for example, silicon rubber having rubber hardness degree of 40° (JISA), and by causing an end portion of the developing blade 4 to abut on a surface of the developing sleeve 2 at a predetermined position, a toner layer having a uniform thickness can be formed on the surface of the developing sleeve on a downstream side in a rotating direction thereof beyond a position of the developing sleeve 4.

At this time, an abutting force P [P: abutting load (gf) per unit length (1 cm) in a longitudinal direction of the developing sleeve] applied when the developing blade 4 abuts on the developing sleeve 2 is set to about 30 gf/cm. An abutting width (nip) of the developing sleeve 2 and the developing blade 4 is set to 1.0 mm, and a distance from an uppermost-stream position to the rotating direction of the developing sleeve to a free end of the developing blade is set to 2.0 mm. A developer amount (toner coat amount) W on the developing sleeve 2 under such conditions becomes about 1.30 (mg/cm²).

A rotary T stirring rod 6 and a rotary D stirring rod 7 are disposed in the developing hopper 5 containing the toner and near the developing sleeve 2, and such a configuration is adopted that the toners in the developing hopper 5 and near the developing sleeve 2 are stirred by both the stirring rods 6 and 7, and the toner in the developing hopper 5 is supplied in a direction of the developing sleeve 2. A conductive detecting member 8 for remaining toner amount detection is provided near the developing sleeve 2, so that a remaining toner amount can be detected to replenish toner at an appropriate time.

Then, after sent near the developing sleeve 2 by the T stirring rod 6 and the D stirring rod 7, monocomponent magnetic toner in the above-described developing hopper 5 is supplied to the developing sleeve 2 by the action of magnetic field formed by the magnetic roller 3, and conveyed in the photosensitive drum direction 11 according to rotation of the developing sleeve 2 (which rotates in a counterclockwise direction). Thereafter, the monocomponent magnetic toner is subjected to charge application and layer thickness restriction at an abutting portion of the developing sleeve 2 and the developing blade 4 and is conveyed to a developing region formed by the developing sleeve 2 and the photosensitive drum 11.

When a electrostatic latent image on the surface of the photosensitive drum 11 is developed by a developing apparatus having such a configuration, an alternating voltage obtained by superimposing an alternating current on a direct current is applied on the developing sleeve 2 from a bias supply (not shown) to form a development electric field between the developing sleeve 2 and the photosensitive drum 11, and development of an electrostatic latent image is performed by the electric field. A developing bias obtained by superimposing an AC (rectangular wave Vpp=1600V, f=2400 Hz) on a direct-current voltage (Vdc=−500V) is applied to the developing sleeve 2 at this time. The photosensitive drum 11 is uniformly charged to charged potential Vd=−700V by a charging device (not shown) and is thereafter exposed by a laser according to an image signal, so that an electrostatic latent image is formed on the surface of the photosensitive drum 11 (Incidentally, the exposed portion becomes Vl=−150V). The exposed Vl portion is reversely developed with negatively charged toner by the developing apparatus to develop the electrostatic latent image.

Here, the above-described magnet roller 3 is configured so as to generate a magnetic attractive force which is a resultant force of an attractive force based on a magnetic flux density of a normal line direction and an attractive force based on a magnetic flux density of a tangential line direction on the developing sleeve 2 by the magnet roller 3, and in particular a main magnetic pole S1 is disposed so as to have a peak of the magnetic flux density of the normal line direction near the closest position of the developing sleeve 2 and the photosensitive drum 11.

A magnetic attractive force pattern of the magnet roller 3 is as shown in FIG. 2, for example. That is, in FIG. 2, a magnetic flux density pattern in the normal line direction of the magnet roller 3 is shown by a thick solid line, and a magnetic attractive force pattern is shown by a thin solid line in the first embodiment of the present invention. A magnetic flux density pattern in a normal line direction is shown by a thick broken line and a magnetic attractive force pattern is shown by a thin broken line in the conventional magnet roller. In FIG. 8, only the magnetic attractive force pattern in the first embodiment of the present invention is extracted and shown.

As understood from FIG. 2 and FIG. 8, in the magnet roller 3 used in the first embodiment, when compared with the conventional magnet roller, a maximum value F0 of the magnetic attractive force is positioned on a downstream side in a rotating direction of the developing sleeve indicated by an arrow beyond a peak angular position of the main magnetic pole S1, and the pattern has a peaked waveform shape. A minimum value F2 of the magnetic attractive force is constituted so as not to be present near the center of the peak angle of the S1 pole of the main magnetic pole.

More particularly, the maximum value F0 of the magnetic attractive force is positioned on the downstream side by at least 8° or more from a peak position of the magnetic flux density in the normal line direction of the main magnetic pole S1, and a half-value width of the maximum value F0 of the magnetic attractive force has a peaked distribution of 54° or less and 90% width of the maximum value F0 of the magnetic attractive force is set to 20° or less. Incidentally, the above-described half-value width of the magnetic attractive force is also called 50% width, and expressed by a central angle at a position where a value of the magnetic attractive force is a half (50%) value of a peak value in the normal line direction. Therefore, 90% width means a central angle in a position where a value of the magnetic attractive force is a 90% value of the peak value in the normal line direction.

Regarding such a configuration, the present inventor(s) has observed “trailing” and “leading” when the magnet of the embodiment is used and when the conventional magnet is used, as shown in the following table 1. That is, a relationship among an angle, a peak value, and a value of a half value width of the magnetic attractive force F obtained when the magnetic attractive force patterns shown in FIG. 2 to FIG. 7 are swung, a trailing index, and leading generation Vback is shown in the following table 1.

TABLE 1

| | Angle of | | | | |
|---|---|---|---|---|---|
| | magnetic | | | | |
| | attractive | | | | |
| | force F0 | | | | |
| | (degree on | | | | |
| | downstream | | half-value | | |
| | side | | width of | | |
| | beyond S1 | magnetic | magnetic | | leading |
| Magnet | pole peak | attractive | attractive | trailing | generation |
| roller | angle) | force F0 | force F0 | index | Vback[V] |
| Conventional | 0° | 1.13 nN | 66° | 35.5 | −160 |
| magnet | Same as S1 | | | | |
| | pole peak | | | | |
| First | 8° | 2.05 nN | 41° | 9.7 | −215 |
| Embodiment | downstream | | | | |
| Second | 9° | 1.70 nN | 54° | 15.2 | −210 |
| Embodiment | downstream | | | | |
| Comparative | 6° | 1.67 nN | 49° | 41.8 | −175 |
| example 1 | downstream | | | | |
| Comparative | 1° | 1.67 nN | 103° | 46.7 | −205 |
| example 2 | downstream | | | | |

The trailing index at this time is obtained by measuring an area of trailing and multiplying the area by a coefficient according to the area, where a bigger index shows a worse trailing, and a smaller index shows a better trailing. The leading generation Vback is a contrast where occurrence of leading starts, and wider latitude can be taken according to increase of a minus figure of the leading generation Vback. Incidentally, the half-value width of the magnetic attractive force is shown by a value of an angle (elevation angle) formed by a line connecting a point on the developing sleeve in the maximum value of a magnetic attractive force line and two points which are a ½ value of the maximum value F0 of the magnetic attractive force.

As apparent from the above table 1, FIG. 4, and FIG. 8, the magnet roller in the embodiment 1 of the present invention shows a narrow and peaked waveform shape such that the maximum value F0 of the magnetic attractive force near the main magnetic pole S1 is positioned on the downstream side by 8° from the peak angle of the main magnetic pole S1, the half-value width is 41°, and the 90% width is 12°. Thus the trailing index is 9.7, which is improved largely as compared with the conventional magnet. In the leading generation Vback, the latitude becomes wider by 55V.

On the contrary, a magnet roller in the comparative example 1 shows a peaked waveform shape such that the maximum value F0 of the magnetic attractive force is positioned on an upstream side by 6° from the S1 pole peak angle and the half-value width is 49° but the trailing index is 41.8, which is a bad result. The leading generation Vback is improved by latitude of 15V. As understood from this result, it has been understood that, when the magnetic attractive force is set on an upstream side, image quality degrades and leading latitude is not improved so much.

A magnet roller in the comparative example 2 shows a broad waveform shape such that the maximum value F0 of the magnetic attractive force is positioned on an upstream side by 1° from the 51 pole peak angle, and the half-value width is 103°. As compared with the conventional magnet roller, the trailing index gets worse largely. However, the leading latitude becomes wider by 45 V. As understood from the result, it has been understood that, when the half-value width of the magnetic attractive force F is made wide to have a broad waveform shape, the leading latitude becomes wider, but trailing gets worse.

Further, as apparent from the above-described table 1 and FIG. 5, a second embodiment according to the present invention shows a broad waveform such that the half-value width is 54° and 90% width is 17°, which is slightly wider than a magnetic attractive force waveform of the first embodiment, but a position of the magnetic attractive force F is set in downstream by 9°. It is understood that the trailing index is 15.2 and such a wide leading generation Vback as −210 V can be taken, which is not so much as the magnet roller of the first embodiment.

From such results of the first and second embodiments and the comparative examples 1 and 2, when the magnet roller is set such that the magnetic attractive force F0 is set on a downstream side by at least 8° or more from the S1 pole peak angle, and the half-value width of the magnetic attractive force F is set to 54° or less, an excellent magnet roller which satisfies both trailing and leading can be obtained. As can be understood from the above result, the minimum magnetic attractive force F2 is not necessarily positioned near the S1 pole peak angle.

On the other hand, in a third embodiment of the present invention shown in FIG. 9, the developing apparatus is disposed in a process cartridge 20 which can be attachably and detachably accommodated in the image forming apparatus main body, and such a configuration is adopted that either one or a combination of at least two of the above-described photosensitive drum 11, a charging device 21 as a process unit acting on the photosensitive drum 11, a cleaning device 24, and a waste toner container 23 containing a cleaned developer, and the developing apparatus described in the above-described first or second embodiment are respectively disposed in the process cartridge 20.

More particularly, in the process cartridge 20 attachably and detachably accommodated in the image forming apparatus, the photosensitive drum 11 is disposed near an opening portion in a casing which can be contained in the image forming apparatus, and the developing apparatus 1 which develops an electrostatic latent image on the photosensitive drum 11 is disposed at a position opposite to the photosensitive drum 11. The developing apparatus 1 is the same as in the above-described first embodiment, the developing sleeve 2 is disposed at a position opposite to the photosensitive drum 11, the developing blade 4 is disposed such that an end portion of the developing blade 4 abuts on the surface of the developing sleeve 2, and the developing hopper 5 is disposed so as to be capable of supplying toner near the developing sleeve 2.

The cleaning device 24 having a cleaning blade 22 is disposed in the casing on the side opposite to the developing apparatus side of the photosensitive drum 11, and residual toner adhered on the surface of the photosensitive drum 11 after transferring step is scrapped off by the cleaning blade 22 and can be received in the waste toner container 23 of the cleaning device 24. The process cartridge 20 is configured such that the charging device 21 which charges the photosensitive drum 11 is disposed in the casing on an upstream side in the rotating direction of the photosensitive drum 11 beyond the developing sleeve 2 and before the cleaning device 24. Incidentally, either one or a combination of at least two of the photosensitive drum 11, the charging device 21, the cleaning device 24 and the waste toner container 23, and the developing apparatus may be combined to be contained in the casing of the process cartridge.

Incidentally, the same magnet roller 3 as used in the first embodiment is fixedly disposed inside the above-described developing sleeve 2, the N1 pole, the S1 pole, the N2 pole, and the S2 pole can be respectively formed on the surface of the developing sleeve 2 by the magnet roller 3 according to the same positional relationship in the first embodiment, and values of an angle and a half-value width of the magnetic attractive force F become the same values in the first embodiment. Incidentally, as a magnet roller, the magnet roller used in the second embodiment can also be used.

The process cartridge 20 having the configuration is set at a predetermined position of the image forming apparatus and can perform image formation in a predetermined process, and when reaching the end of its life due to consumption of toner or wearing of members in the cartridge, the process cartridge 20 can be exchanged with a new process cartridge to perform high-quality-image formation continuously.

Since an integrated process cartridge is made by disposing the developing apparatus having the developing sleeve 2, the developing blade 4 and the like, the photosensitive drum 11, the charging device 21, and the cleaning device 24 in the casing which can be accommodated in the image forming apparatus in this manner, such an effect explained in the first and second embodiments can be obtained that trailing and leading are prevented and excellent image formation can be performed, and additionally, exchange of each component in the cartridge and a waste toner processing can be performed easily without making surroundings dirty with toner. Therefore, maintenance easiness of the image forming apparatus can be improved dramatically, and since a principal component in an electrophotographic system is exchanged with a new one by exchanging the cartridge, a high-quality image can be maintained constantly and easily.

The embodiments of the invention which has been made by the present inventor(s) have been specifically explained above, but it is obvious that the present invention is not limited to the embodiments, and can be modified variously without departing from the scope of the present invention.

For example, the above-described embodiments of the present invention can be applied similarly to another image forming apparatus such as a copying machine except for a printer.

### INDUSTRIAL APPLICABILITY

The above-described image forming apparatus according to the present invention can be widely applied to various image forming apparatuses such as a copying machine, including an image forming apparatus such as a printer.

### BRIEF DESCRIPTION OF THE DRAWINGS

FIG. 1 is a sectional schematic view of a developing apparatus according to an embodiment of the present invention;

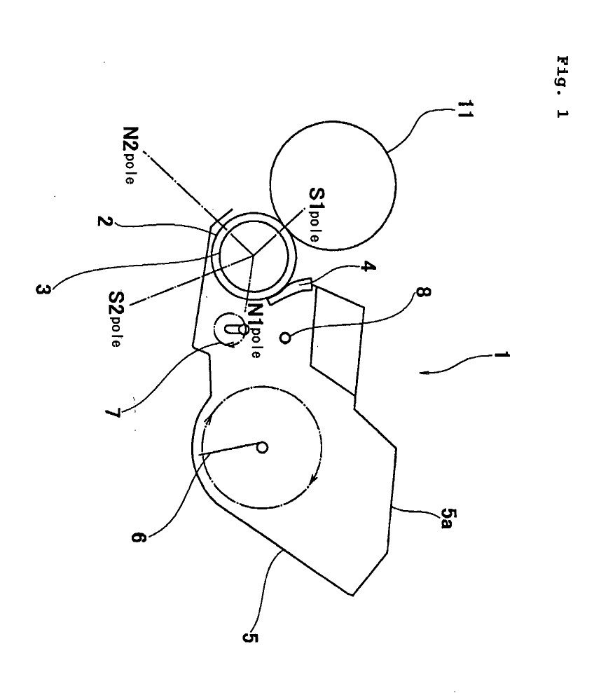

FIG. 2 is an explanatory diagram showing a relationship between a magnetic flux density pattern and a magnetic attractive force pattern in a magnet roller;

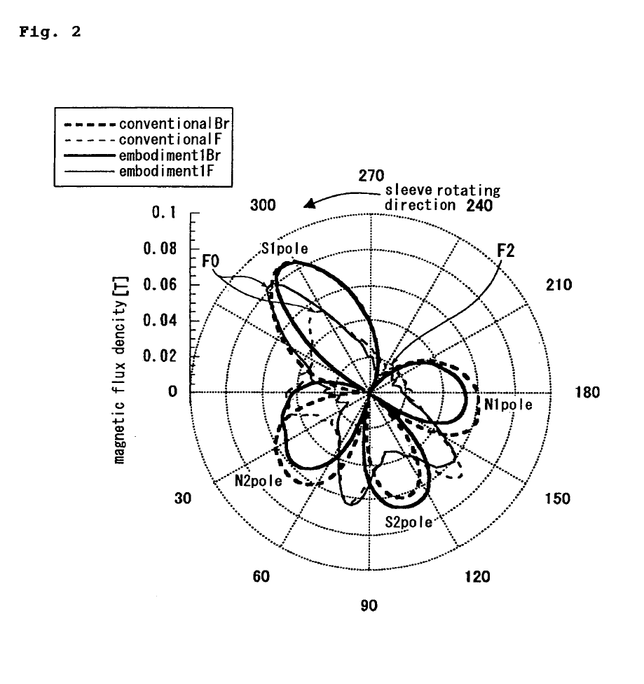

FIG. 3 is an explanatory diagram showing a magnetic flux density in a normal line direction and a magnetic attractive force of a conventional magnet roller;

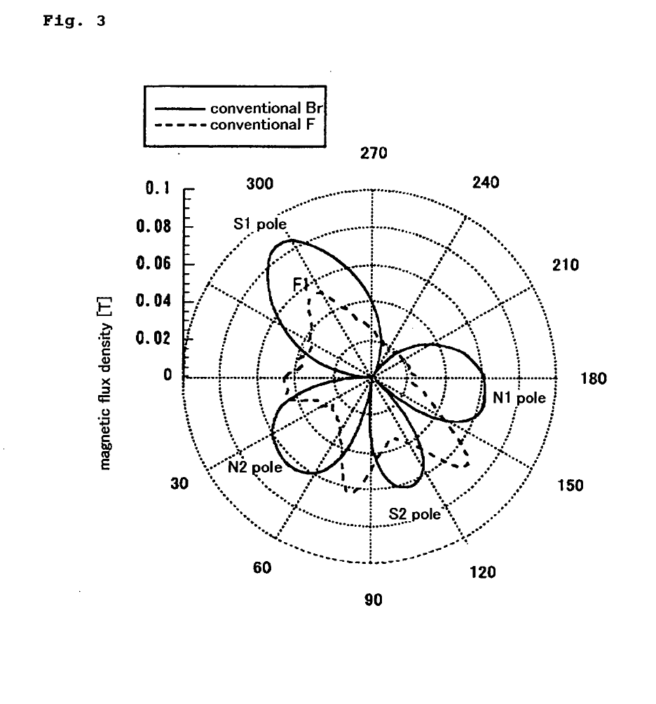

FIG. 4 is an explanatory diagram showing a magnetic flux density in a normal line direction and a magnetic attractive force of a magnet roller of a first embodiment;

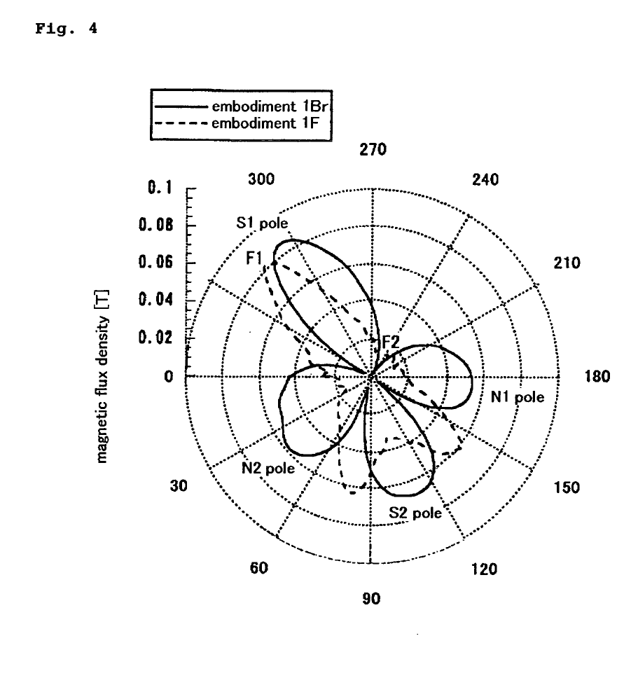

FIG. 5 is an explanatory diagram showing a magnetic flux density in a normal line direction and a magnetic attractive force of a magnet roller of a second embodiment;

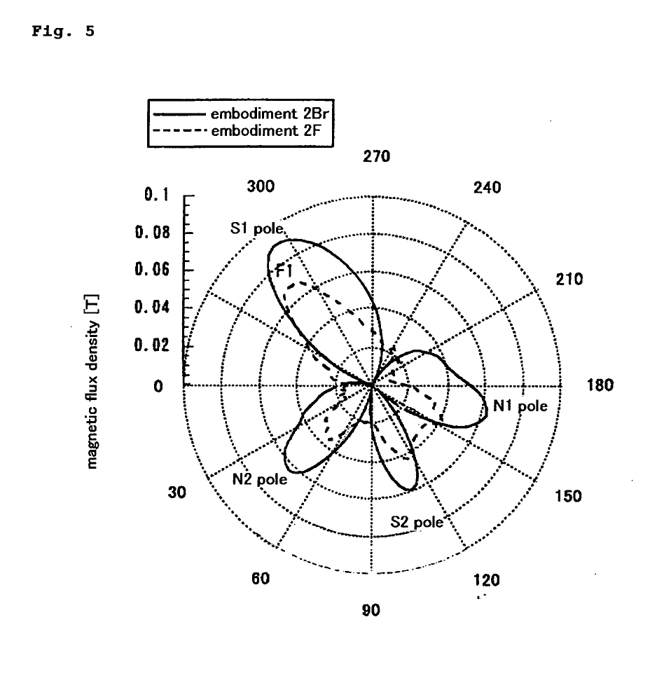

FIG. 6 is an explanatory diagram showing a magnetic flux density in a normal line direction and a magnetic attractive force of a magnet roller of a comparative example 1;

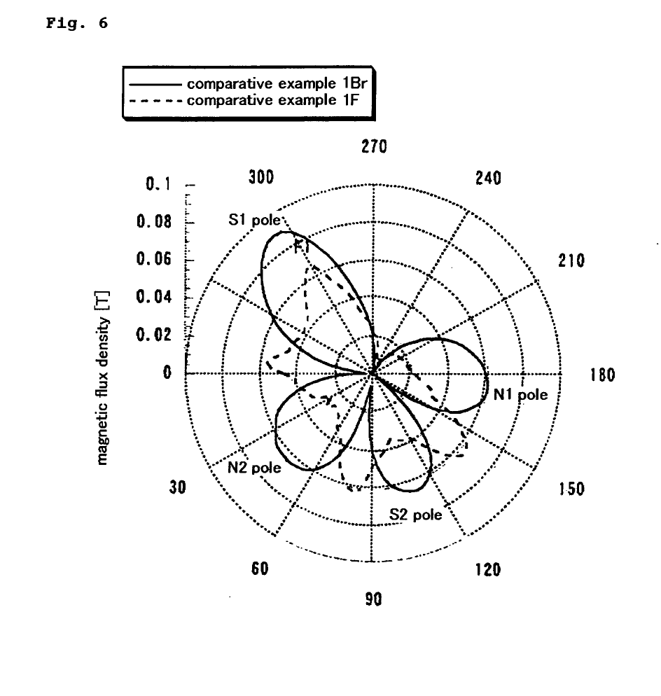

FIG. 7 is an explanatory diagram showing a magnetic flux density in a normal line direction and a magnetic attractive force of a magnet roller of a comparative example 2;

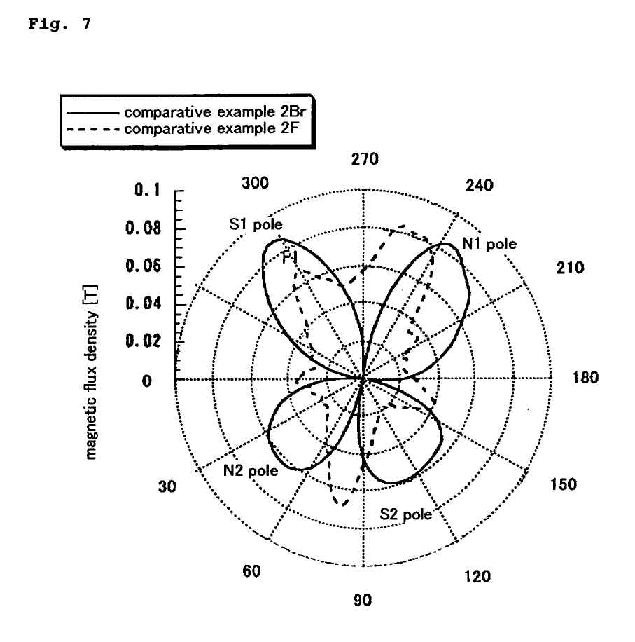

FIG. 8 is an explanatory diagram of the magnetic attractive force pattern in the magnet roller extracted from the first embodiment of the present invention shown in FIG. 2 to be shown; and

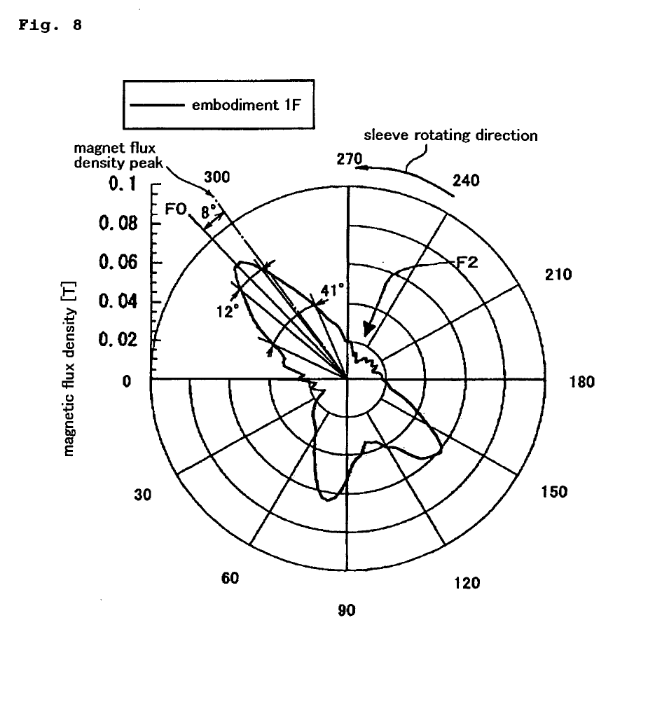

FIG. 9 is a sectional schematic view showing a process cartridge according to a third embodiment.

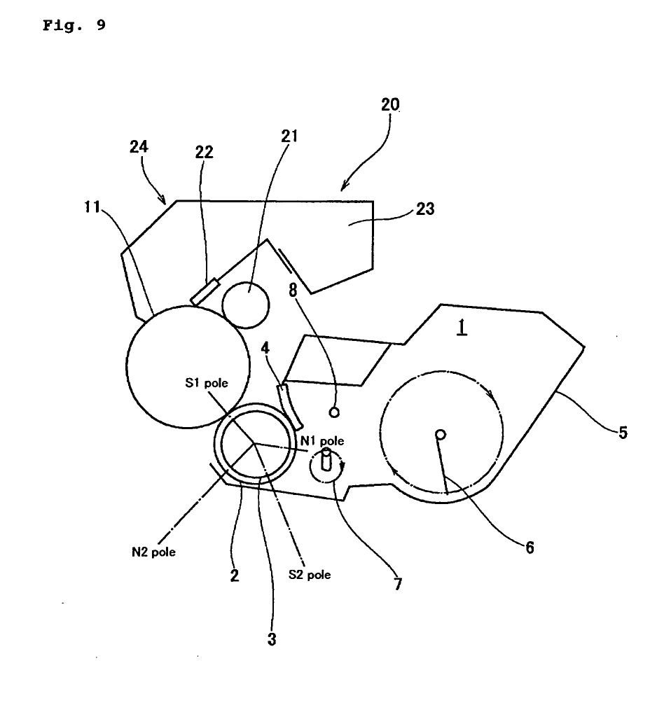

### EXPLANATION OF REFERENCE NUMERALS

1 developing apparatus
2 developing sleeve (developer carrier)
3 magnet roller (magnetic field generating unit)
4 developing blade (developer restricting member)
5 developing hopper
6 T stirring rod
7 D stirring rod
8 remaining toner amount detecting member
11 photosensitive drum (electrostatic latent image carrier)
20 process cartridge
21 charging device
24 cleaning device

1. A developing apparatus comprising a developer carrier which is disposed opposite to an electrostatic latent image carrier and carries a developer to rotate, and a magnetic field generating unit which is fixedly disposed inside the developer carrier and has a plurality of magnetic poles including a main magnetic pole positioned in a developing region,
the main magnetic pole of the above-described magnetic field generating unit having a peak of magnetic flux density in a normal line direction near a proximity position of the electrostatic latent image carrier and the developer carrier, and being configured so as to generate a magnetic attractive force which is a resultant force of an attractive force based on the magnetic flux density in the normal line direction and an attractive force based on magnetic flux density in a tangential line direction on the developer carrier by the magnetic field generating unit, wherein
a magnetized pattern where a maximum value F0 of the magnetic attractive force F is positioned on a downstream side in a rotating direction of the above-described developer carrier from a peak position of the magnetic flux density in the normal line direction of the main magnetic pole, and
a half-value width of the maximum value F0 of the magnetic attractive force becomes smaller than that of the magnetic flux density in the normal line direction in the main magnetic pole is applied to the magnetic field generating unit.

2. The developing apparatus according to claim 1, wherein the developer have a weight average particle diameter of 3.0 to 7.2 μm and an MI value of 3 to 30 g/10 min, and
a developer amount W [W: toner coat amount (mg) per square centimeter of a surface of the developer carrier] layered on the developer carrier satisfies 0.6≦W≦1.5.

3. The developing apparatus according to claim 1 or 2, wherein the maximum value F0 of the magnetic attractive force is positioned on the downstream side by at least 8° or more in the rotating direction of the developer carrier from the peak position of the magnetic flux density in the normal line direction of the main magnetic pole, and
a half-value width of the maximum value F0 of the magnetic attractive force has a distribution within a range of 54° or less.

4. The developing apparatus according to any one of claims 1 to 3, wherein
a 90% width of the maximum value F0 of the magnetic attractive force is set to 20° or less.

5. A process cartridge configured with either one or more than one of an electrostatic latent image carrier, a charging device, a transferring device, and a cleaner, and a developing apparatus which are disposed in a casing attachably and detachably accommodated in an image forming apparatus main body, the developing apparatus comprising a rotatable developer carrier, a magnetic field generating unit which is fixedly disposed inside the developer carrier and has a plurality of magnetic poles including a main magnetic pole positioned in a developing region, a developer restricting member abutting on the developer carrier, and a developing container containing a developer supplied to the developer carrier,
the developer having a weight average particle diameter of 3.0 to 7.2 μm and an MI value of 3 to 30 g/10 min, and a developer amount W [W: toner coat amount (mg) per square centimeter of a surface of the developer carrier] layered on the developer carrier satisfying 0.6≦W≦1.5, wherein
the main magnetic pole has a peak of magnetic flux density in a normal line direction at a proximity position of the electrostatic latent image carrier and the developer carrier,
the magnetic field generating unit generates a magnetic attractive force which is a resultant force of an attractive force based on the magnetic flux density in the normal line direction and an attractive force based on magnetic flux density in a tangential line direction on the developer carrier,
a maximum value F0 of the magnetic attractive force is positioned on a downstream side in a rotating direction of the developer carrier by at least 8° or more from the peak position of the magnetic flux density in the normal line direction of the main magnetic pole, and
a half-value width of the maximum value F0 of the magnetic attractive force has a distribution of 54° or less.

6. The process cartridge according to claim 5, wherein a 90% width of the maximum value F0 of the magnetic attractive force is set to 20° or less.

7. An image forming apparatus wherein a developing apparatus according to any one of claims 1 to 4, or a process cartridge according to claim 5 or 6 is provided.
